(19) United States
(12) Patent Application Publication
(10) Pub. No.: US 2004/0222164 A1
(43) Pub. Date: Nov. 11, 2004

(54) Method and apparatus for using peroxide and alkali to recover bitumen from tar sands

(76) Inventors: Lawrence Conaway, Niagara Falls, NY (US); Michael R. Keller, Tulsa, OK (US); Roger K. Noble, Tulsa, OK (US)

Correspondence Address: Robert C. Brown, 1207 Sandhurst Drive, Tallahassee, FL, 32312, US

(21) Appl. No.: 10/865,641

(22) Filed: Jun. 10, 2004

Related U.S. Application Data
(63) Continuation-in-part of application No. 10/715,186, filed on Nov. 17, 2003.
Application No. 10/715,186 is a continuation-in-part of application No. 10/442,583, filed on May 21, 2003, now abandoned.
Application No. 10/442,583 is a continuation-in-part of application No. 09/883,718, filed on Jun. 18, 2001, now Pat. No. 6,576,145.
Application No. 09/883,718 is a continuation-in-part of application No. 09/451,293, filed on Nov. 30, 1999, now Pat. No. 6,251,290.
Application No. 09/451,293 is a continuation-in-part of application No. 09/304,377, filed on May 4, 1999, now Pat. No. 6,096,227.
Application No. 09/304,377 is a continuation-in-part of application No. 08/971,514, filed on Nov. 17, 1997, now Pat. No. 5,928,522.
Application No. 08/971,514 is a continuation-in-part of application No. 08/807,643, filed on Feb. 27, 1997, now Pat. No. 5,797,701.

(51) Int. Cl. C02F 1/72

(52) U.S. Cl. 210/759

(57) ABSTRACT

Method and apparatus for treating an ore comprising mineral substrate particles surrounded by hydrocarbon compounds, especially tar sand grains, process tailings, and contaminated soils, to recover a hydrocarbon portion and a cleaned substrate portion. In a preferably continuous process, hydrocarbonaceous rock, sand, ore, tailings, or soil containing bitumen, petroleum, and/or kerogen may be crushed or otherwise comminuted as needed to provide a particle size of sand or smaller. The ore is mixed with water to form a slurry, which may also contain alkali, for example, sodium hydroxide or sodium bicarbonate. The slurry is heated to about 80° C. and is intensively sheared to condition the slurry for separation, preferably by shear-fracture of the hydrocarbon layers surrounding the particles in the grains. The conditioned slurry is blended with a peroxide in aqueous solution, preferably hydrogen peroxide, which enters the grains and is decomposed therein, creating bubbles of free oxygen within the grains which disrupt the hydrocarbon envelope. In decomposing, the peroxide increases the hydrophilicity of the particle surfaces. Both free and bound hydrocarbons in the ore are thereby released from the mineral substrate particles. The resulting hydrocarbon globules are separated from the substrate particles by flotation, accelerated by attached oxygen bubbles. Alkali and/or peroxide may be added during the flotation process. Water and mineral tailings from the process are substantially free of hydrocarbon contamination and are environmentally suitable for landfill disposal.

### RELATIONSHIP TO OTHER APPLICATIONS AND PATENTS

The present application is a Continuation-In-Part of a pending application, Ser. No. 10/715,186, filed Nov. 17, 2003; which is a Continuation-In-Part of a pending application, Ser. No. 10/442,583, filed May 21, 2003; which is a Continuation-In-Part of an allowed application, Ser. No. 09/883,718 filed Jun. 18, 2001, now matured as U.S. Pat. No. 6,576,145; which is a Continuation-In-Part of an allowed application, Ser. No. 09/451,293 filed Nov. 30, 1999, now matured as U.S. Pat. No. 6,251,290; which is a Continuation-In-Part of an allowed application, Ser. No. 09/304,377 filed May 4, 1999, now matured as U.S. Pat. No. 6,096,227; which is a Continuation-In-Part of an allowed application, Ser. No. 08/971,514 filed Nov. 17, 1997, now matured as U.S. Pat. No. 5,928,522; which is a Continuation-In-Part of an allowed application, Ser. No. 08/807,643 filed Feb. 27, 1997, now matured as U.S. Pat. No. 5,797,701; the relevant disclosures of all of which being herein incorporated by reference.

### FIELD OF THE INVENTION

The present invention relates to methods and apparatus for recovering useful liquid and gaseous hydrocarbons from both naturally-occurring and man-made mixtures of hydrocarbons and mineral substrates; more particularly to methods and apparatus for processing hydrocarbon-containing geologic ores, including tar sands, oil sands, oil sandstones, oil shales, and petroleum-contaminated soils, to recover petroleum-like hydrocarbons, and especially bitumen, kerogen, and/or crude oil, therefrom and to render the mineral substrate residues suitably low in hydrocarbons, acids, and bases for environmentally-acceptable disposal; and most particularly to a method and apparatus for separating bitumen from particulates in tar sand and oil sand grains, using hydrogen peroxide in combination with a caustic agent. As used hereinafter, the term “tar sands” shall be taken to mean any or all of the above hydrocarbonaceous ores.

### BACKGROUND OF THE INVENTION

As used herein, “hydrocarbonaceous deposit” is to be taken to include tar sands, oil sands, oil sandstones, oil shales, all other naturally-occurring geologic materials having hydrocarbons contained within a generally porous rock-like inorganic matrix, and non-naturally-occurring hydrocarbon-containing effluents such as tailings, muds, slurries, colloids, and the like from previous partial-recovery processes. The matrix may be loose, friable, or indurate. The hydrocarbons may be in direct contact with the mineral substrate or may be separated therefrom by a third material, for example, water. Contaminated soil is to be taken to include soils which have been non-naturally impregnated with hydrocarbons, as is known to occur in petroleum drilling, well operating, storage, refining, transport, and dispensing processes.

Tar sands are naturally-occurring geological formations found in, for example, Canada (Alberta) and the United States (Wyoming). Such sands have potential for yielding large amounts of petroleum. Tar sands are porous, generally loose or friable, and typically contain substantial amounts of clay and have the interstices filled with high-viscosity hydrocarbons known generally in the art as bitumen. In addition, particles of clay or sand are surrounded typically by bitumen to form discrete grains. Most of these tar-like bituminous materials are residues remaining after lighter (lower molecular weight) hydrocarbons have escaped through geologic mechanisms over geologic time or have been degraded through the action of microorganisms, water washing, and possibly inorganic oxidation.

Very extensive tar sand deposits occur in northern Alberta, Canada along the Athabasca River and elsewhere. Tar sand layers in this area may be more than 60 meters thick and lie near the surface over a total area of about 86,000 km². They are estimated to contain a potential yield in excess of 1.6 trillion barrels of oil.

Oil shales are related to oil sands and tar sands; however, the substrate is a fine-grained laminated sedimentary rock typically containing an oil-yielding class of organic compounds known as kerogen. Oil shale occurs in many places around the world. Particularly kerogen-rich shales occur in the United States, in Wyoming, Colorado, and Utah, and are estimated to contain in excess of 540 billion potential barrels of oil.

Hydrocarbons recoverable from tar sands and oil shales may comprise, but are not limited to, bitumen, kerogen, asphaltenes, paraffins, alkanes, aromatics, olefins, naphthalenes, and xylenes.

In the known art of petroleum recovery from hydrocarbonaceous deposits, the high molecular weight bituminous or kerogenic material may be driven out of the sands, sandstones, or shales with heat. For example, in a known process for recovering kerogen from oil shale, crushed shale is heated to about 480° C. to distill off the kerogen which is then hydrogenated to yield a substance closely resembling crude oil. Such a process is highly energy intensive, requiring a portion of the process output to be used for firing the retort, and thus is relatively inefficient. Also, a significant percentage of the kerogen may not be recovered, leaving the process tailings undesirable for landfill.

Other known processes, for recovering bitumen from tar sands for example, require the use of caustic hot water or steam. For example, a process currently in use in Canada requires that a hot aqueous slurry of tar sand be mixed with aqueous caustic soda comprising sodium hydroxide and/or sodium bicarbonate to separate the bitumen from the sand grains and to fractionate the bitumen into lower molecular weight hydrocarbons which may then be separated from the mineral residues and refined further like crude oil.

This process has several serious shortcomings. First, it is relatively inefficient, typically recovering 70% or less of the hydrocarbons contained in the sands. “Free” hydrocarbons, that is, compounds mechanically or physically contained interstitially in the rock, may be recovered by this process; but “bound” hydrocarbons, that is, compounds electrostatically bound by non-valence charges to the surface of clays or other fines having high electronegative surface energy, are not readily released by some prior art processes. In fact, high levels of caustic may actually act to inhibit the desired release of organic compounds from such surfaces and are known to emulsify released bitumen with water, forming a stable colloid and making later separation of bitumen from water very difficult. Thus, the prior art process can be wasteful in failing to recover a substantial portion of the potential hydrocarbons, and the mineral substrate residue of the process may contain substantial residual hydrocarbon, making it environmentally unacceptable for landfill. Typically, the aqueous tailings of prior art processes require ponding, sometimes for years, to permit separation of water and bitumen from the suspended and entrained particles. The volumes and surface areas of such ponds in Alberta are enormous.

Second, the wet sand and clay residues can be caustic and may not be spread on the land or impounded in lagoons without extensive and expensive neutralization.

Third, the caustic aqueous residual may contain high levels of petroleum, which is non-recoverable and also toxic in landfill. Such residual also has a high Chemical Oxygen Demand (COD), making ponds containing such residual substantially anoxic and incapable of supporting plant or animal life and highly dangerous to waterfowl.

Fourth, oils recovered by the prior art process typically have high levels of entrained or suspended fine particulates which must be separated as by gravitational settling, filtration, or centrifugation before the oils may be presented for refining. These particulates may be emulsified with the oils and can be extremely difficult to separate out.

Fifth, the present-day cost of oil recovered from Albertan tar sands by prior art process may require a substantial governmental subsidy to match the world spot price of crude oil.

Sixth, the process is highly sensitive to natural oxidation of ores, being most successful on freshly-mined ores which have not been weathered nor exposed for long to atmospheric conditions. Exposure to air for only a few days can render the ores untreatable by this method.

Alternatively, it is known to use hydrogen peroxide in an aqueous slurry to separate bitumen from mineral particulates in a tar sand or oil sand.

Canadian Patent Application No. 2,177,018 (“'018”), laid open for public inspection Nov. 22, 1997, and abandoned Dec. 21, 2000, discloses a batch process for separating oil and bitumen from sand by mixing sand and water in a tank to form an aqueous slurry; adding a water solution of hydrogen peroxide to the aqueous slurry; agitating the slurry containing the hydrogen peroxide; skimming an upper froth layer containing oil and bitumen; and removing a lower clean sand layer and a middle clean water layer from the tank.

The disclosed process is relatively slow and low in capacity. Mechanical agitation of the slurry is relatively low, being provided specifically by injection of gas bubbles through an air injection assembly. Use of a mechanical mixer, for example, is not suggested. Hydrogen peroxide is taught as “a catalyst initiating a vigorous reaction.” For overall speed, the process relies on the rate at which the hydrogen peroxide attacks the tar sand granules, separating the slurry into “an upper froth layer, a middle clean water layer, a lower clean sand layer, and a clay layer.” The disclosed process does not teach or suggest that vigorous mechanical agitation and/or substantially elevating the temperature above 45° C. may accelerate the process or increase the overall yield.

U.S. Pat. No. 6,576,145, issued Jun. 10, 2003, discloses a continuous process for separating hydrocarbons from a mixture of hydrocarbons and a particulate mineral substrate by feeding a predetermined amount of the mixture into a mixing vessel; adding a predetermined amount of water to the mixture to form an aqueous slurry; tempering the slurry to about 80° C.; adding a predetermined amount of aqueous hydrogen peroxide to the heated slurry; agitating the heated slurry containing the hydrogen peroxide by passing the slurry through a linear oxidation vessel at a low axial velocity and a high radial and rotational velocity to release hydrocarbons from the mineral substrate and to reduce the molecular weight of some of the hydrocarbons; and passing the slurry through a separator wherein the mineral substrate is separated from the water and the hydrocarbons also are separated from the water.

The disclosed method improves upon the disclosure of '018 in three ways: first, by recognizing the benefit of elevating temperature substantially above 45° C., which greatly enhances bitumen recovery by reducing viscosity and also speeds up the reaction of hydrogen peroxide; and second, by recognizing the benefit of a continuous process using a plurality of specialized, linked vessels; and third, by recognizing the importance of intense mechanical shear in assisting attack on the sand grains by hydrogen peroxide.

However, this patent does not disclose or suggest that a period of intense shear of the slurry prior to addition of the hydrogen peroxide may be beneficial in shortening the required reaction time and thus increasing throughput.

Further, this patent disclosure purports that an important element in separation of bitumen from mineral grain is oxidation and chain-breaking of the bitumen compounds by the peroxide.

Further, this patent disclosure relies primarily on gravitational separation of the separated reaction products by density difference between bitumen and sand or clay particulates relative to water.

Further, this patent disclosure teaches to add aliquots of aqueous hydrogen peroxide at a plurality of locations along the flowpath of the slurry.

It is a principal object of the invention to provide an improved process for recovering hydrocarbons from tar sand deposits, oil sand deposits, and/or caustic tailings in greater than 90% yield.

It is a further object of the invention to provide an improved recovery process wherein physical separation of bitumen globules from mineral particulates is assisted by preferential flotation of the bitumen globules.

### SUMMARY OF THE INVENTION

Briefly described, individual grains in an oil-sand or tar-sand ore typically comprise an envelope of bitumen surrounding a mineral substrate particle of clay or sand. In so-called “water wet” ores, a thin water layer is present between the bitumen envelope and the substrate particle. In “oil wet” ores, a water layer is absent or nearly so. As used hereinafter, the term “bitumen” should be understood to mean bitumen itself and, for simplicity in discussion herein, all other hydrocarbonaceous materials including but not limited to kerogen, asphaltenes, paraffins, alkanes, aromatics, olefins, naphthalenes, and xylenes.

In a bitumen-recovery process in accordance with the invention, the ore may be preliminarily screened to eliminate rocks or plant materials which may have been included from the soil overburden of the ore deposit.

In a first recovery process step, the ore is mixed with water to form a slurry which may be heated to about 80° C. or higher. The type of water is non-critical and may include fresh water, salt water, seawater, tailing pond water, recycled process water, and combinations thereof. The slurry may be acidic, neutral, or alkaline. When the slurry is to be used as the primary means for transport of the ore from the mining site to a processing plant, such as by pumping the slurry through a pipeline, the tempering may be deferred to later in the process.

In a second recovery process step, the slurry is tempered to about 80° C. as needed, and the hot slurry is strongly agitated at high liquid shear rates, preferably exceeding slurry average velocities of 5 meters per second, for at least one minute and preferably for several minutes, by which action the bitumen envelope is mechanically thinned, distorted, and ultimately fractured, exposing the water layer and/or mineral grain within. Transport of the slurry through a delivery pipeline, as described above, may serve to satisfy at least a part of the intense shear requirement disclosed in this step.

In a third recovery process step preferably subsequent to the intense shear step but optionally coincident therewith, an aqueous solution of hydrogen peroxide is added to the slurry, and agitation is maintained sufficient to rapidly disperse the hydrogen peroxide throughout the slurry. The hydrogen peroxide enters the bitumen envelope through the previously-formed fractures and reacts with the surface of the mineral substrate to reduce wettability of the substrate to hydrocarbons. The hydrogen peroxide is thereby decomposed to oxygen and water, generating free oxygen gas which coalesces into small bubbles attached preferentially to the bitumen envelope. As more oxygen gas is liberated, bubbles continue to form and to expand in the space within the bitumen envelope between the envelope and the substrate, eventually rupturing the envelope and allowing the substrate particle to become separated therefrom.

The slurry may include one or more alkali materials if desired, for example, sodium hydroxide, sodium bicarbonate, etc. As used herein, the terms caustic, base, basic, alkali, and alkaline should be considered equivalent and interchangeable and should be taken to mean creating aqueous conditions having a pH greater than 7.0. Within the scope of the invention, addition of alkali materials to the aqueous slurry, when so desired, may be made at any point in the process from initial water addition to the raw ore through final bitumen recovery. In dealing with tailing pond materials from previous partial recovery by prior art caustic processes, the starting slurry by already be significantly alkaline.

Further, pH of the water or slurry may be adjusted as desired at any point in the process by addition of acid.

In a fourth recovery process step, bitumen is recovered by flotation. The particle has a negative buoyancy in the rapidly-degenerating slurry and begins to settle, whereas the bitumen globules with O₂ bubbles attached are quite positively buoyant and rise to the surface where they form a skimmable froth. Buoyancy may be increased by application of vacuum to the flotation process to increase the size of the oxygen bubbles. Both free interstitial hydrocarbons and those hydrocarbons bound electrostatically to the particles are released from the mineral substrate and separated by such oxygen flotation. In general, flocculants or gas sparging in the settling tank are not required to effect excellent separation, although they may enhance separation in some applications. Also, additional hydrogen peroxide and/or alkali and/or acid may be added as needed.

The water and rock tailings from the process are substantially free of hydrocarbon contamination and are environmentally suitable for disposal.

In a further preferred embodiment, the only wastewater from the process is the water contained in the wet tailings of sand and clay. The remainder of the separated water may be recycled into the mixing stage at the head end of the process. The separated sand can provide excellent filtration of clay particles from water being recycled. Such sand filtration is also environmentally beneficial in restoring the original sand/clay relationship to mineral residues eventually landfilled.

### BRIEF DESCRIPTION OF THE DRAWINGS

The foregoing and other objects, features, and advantages of the invention, as well as presently preferred embodiments thereof, will become more apparent from a reading of the following description in connection with the accompanying drawings, in which:

FIG. 1 is a simplified schematic flowpath of a continuous process for recovering hydrocarbons from hydrocarbonaceous ores, soils, or tailings in accordance with the invention; and

FIG. 2 is a more detailed schematic flowpath of the basic process shown in FIG. 1;

FIG. 3 is a more detailed view of a first stage shearing and separating device shown in FIG. 2;

FIG. 4 is an elevational cross-sectional view taken along line 4-4 in FIG. 3;

FIG. 5 is a graph relating bitumen recovery rate as a function of various process aids;

FIG. 6 is a bar graph showing relative wetting index of sand solids by 1-propanol without and with prior treatment of the sand with hydrogen peroxide;

FIG. 7 is graph showing decomposition rates of hydrogen peroxide in the presence of oil sand, sand, clay, and bitumen; and

FIG. 8 is a schematic diagram showing the sequence of states and events by which the process of the invention is believed by the inventors to proceed.

### DETAILED DESCRIPTION OF THE PREFERRED EMBODIMENT

Since ore volumes to be treated can be relatively large, it is preferable to configure the process for continuous throughput, although semi-continuous and batch systems are within the scope of the invention and all such processes may be configured of known apparatus without undue experimentation or further invention. A continuous throughput process in accordance with the present invention is described below.

The hydrogen peroxide-based process as disclosed in herein incorporated U.S. Pat. No. 6,576,145 ('145) and pending U.S. patent application No. 10/715,186 provides a starting point for an improved peroxide/alkaline process as described herein for treatment of tar sands and oil sands to more simply and economically recover a high percentage of the hydrocarbon content therefrom.

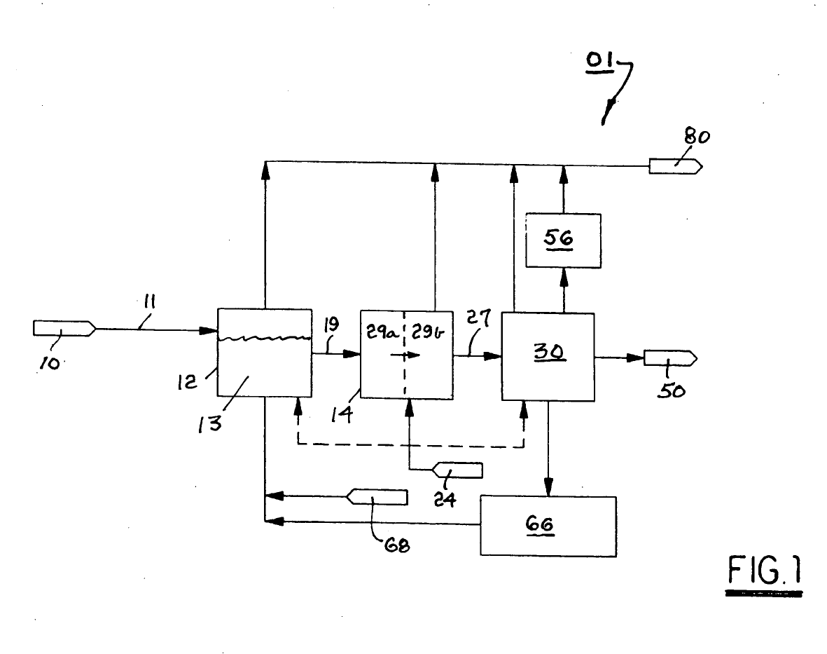

Referring to FIGS. 1 through 4, in a hydrocarbon recovery process and apparatus 01 embodying the invention, a hydrocarbon/substrate mixture, referred to generally herein as tar sand ore, preferably has been mined, crushed, ground, screened, or otherwise pre-treated as needed in a conventional preparation zone (not shown) to eliminate large rocks and debris, for example, by a rotary trommel screen, and to yield an ore feedstock 10 having particles preferably less than about 2 mm in diameter (sand and clay size). The ore may be sprayed with water, preferably heated water, during processing by the trommel screen. The ore is charged through a feeder 11, for example, a screw feeder, into a mixing tank 12, wherein it is mixed with water to form a pumpable slurry 13 having a weight percent proportion of ore to water of between about 0.5:1 and about 2:1. In some applications, the water may advantageously contain alkali materials, for example, sodium hydroxide and/or sodium bicarbonate, such that the pH is above 7.0. Further, in some applications, the slurry may be formed at a mine site and then hydrotransported via pipeline to a processing facility for completion of the separation and recovery process in accordance with the invention. The pH may be adjusted either before or after such hydrotransporting.

The slurry is formed and then agitated by mixer 17 and its temperature is adjusted to between about 20° C. and about 150° C. to begin to release free hydrocarbons from the mineral substrate, soften waxy or ashpaltic hydrocarbon solids, reduce the apparent viscosity of the batch, reduce the density of hydrocarbon fractions within the batch, and begin to break surface adhesion of hydrocarbon compounds bound to substrate surfaces. Preferably, the temperature is adjusted to about 80° C.

As described up to this point, the present process is substantially as disclosed in the '145 patent, except that preferably hydrogen peroxide is not added to the slurry in mixing tank 12, except via recycled process water as described below, and process conditions may be specifically alkaline.

Mixing tank 12 is in communication with a subsequent shearing and separating device 14. For example, connected to mixing tank 12 is agitating and shearing means, preferably in the form of a device 14 into which slurry 13 is preferably pumped by a first transfer pump 15 via line 19. In some installations, line 19 is a relatively long pipe for transfer of slurry 13 from a mixing facility, which may be near the mine site as recited above, to a remote separating facility. In such a pipe, slurry 13 may be exposed advantageously to relatively high shear rates during pumping, preferably about 5 meters per second or higher, during transfer to device 14. The term “shear” as used herein refers to an average mean fluid velocity in any direction. Slurry 13 may also be transferred by gravity feed; also, tank 12 and device 14 may be configured as different parts or different operating phases in a single vessel (not shown), within the scope of the invention.

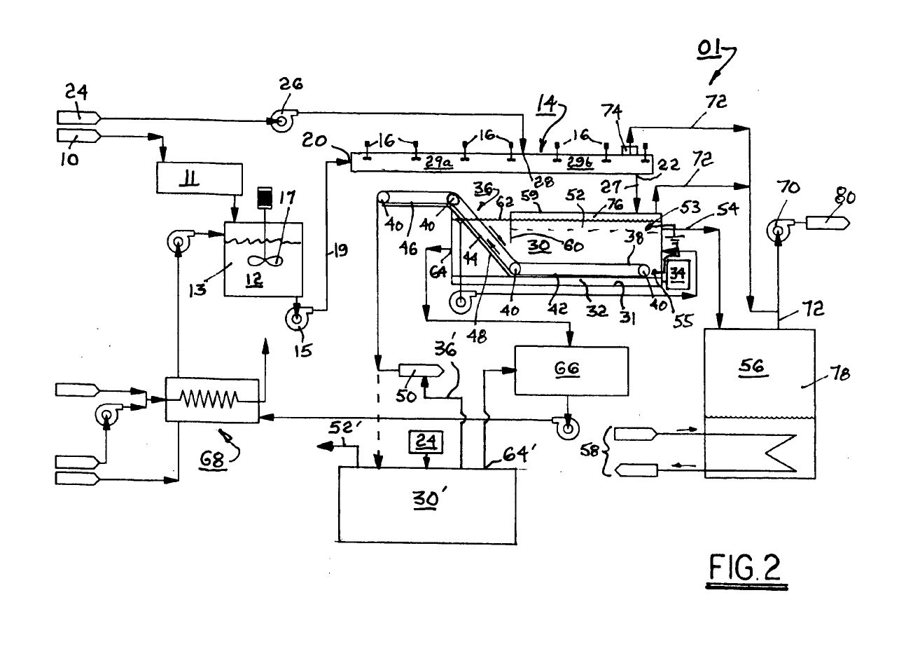

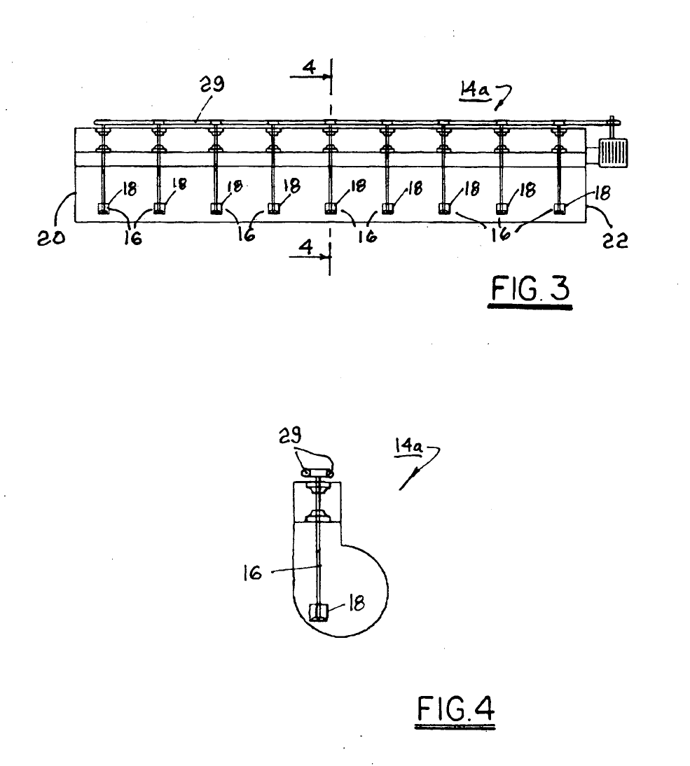

Device 14 is functionally divided into a purely shearing region 29a and a first stage separation region 29b. Device 14 is preferably configured as a relatively long tube 80, preferably disposed horizontally, having both cylindrical 82 and non-cylindrical 84 portions such that a cross-section is substantially in the shape of the inverted letter P or lower-case d (see FIG. 4), such that a plurality of rotary mixing devices, such as mixing means 16, may be readily installed into apparatus 14 at a plurality of locations along the apparatus (see FIGS. 2 and 3). Mixing means 16 in accordance with the invention may be selected from the group consisting of a propeller, a fluid jet nozzle, jet pump, or any other impelling means. A shrouded propeller (impeller) is currently preferred. The impellers may be individually driven as by individual electric motors or may be ganged together with a common drive as by a chain or belt 29 in known fashion, as shown in FIG. 3. Each impeller is preferably provided with a generally cylindrical shroud 18 to narrow the cone of flow turbulence emanating from the mixer. In a currently preferred embodiment, each mixer 16 preferably is disposed non-radially of the tube axis 86; that is, the axis of rotation 88 of the mixer preferably is contained in a first plane and the axis of the tube is contained in a second plane, although both axes may lie in a single plane within the scope of the invention. The axis of rotation forms an angle 90 with the axis of the mixing tube, preferably about 90°. The axis of mixer rotation is preferably generally tangential to the cylindrical portion of the tube, such that the slurry is violently rolled about a horizontal axis (vertical spinning flow while axial flow is horizontal) as it passes horizontally along the tube from an entrance port 20 to an exit port 22. Preferably, device 14 and pump 15 are sized to provide an axial mass flowrate of slurry 13 along the tube of about 0.13 ft/sec, or about 8 ft/min, where slurry temperature is about 80° C. and the process is operated at atmospheric pressure. Device 14 is preferably closed so that at other pressures, for example, from about 0.1 atmospheres up to 5 atmospheres gauge pressure, other temperatures, for example, up to 150° C., and other suitable times are readily determinable by one of ordinary skill in the chemical engineering arts without undue experimentation.

Preferably, the instantaneous shear velocity in the highest-velocity direction within the slurry is at least 1 meter per second and preferably exceeds 5 meters per second. Preferably, the time period of intense agitation and shearing of slurry 13 up to this point, combining any such shearing from transfer in pipe 19 with shearing in section 29a of device 14, is at least 1 minute and preferably up to 15 minutes or more. Longer shearing times are not believed to adversely affect the slurry or the separation process. Such intense shear is believed by the inventors to distort and ultimately fracture the bitumen layer of each tar-sand grain, exposing the water layer and/or the mineral substrate within to subsequent attack by hydrogen peroxide, as described below.

In separation section 29a of device 14, slurry 13 is blended with an aqueous solution containing hydrogen peroxide to produce a treated slurry having a hydrogen peroxide content between about 0.05% and about 10.0% in the water phase by weight. Sodium peroxide is believed to also be functional instead of hydrogen peroxide, but hydrogen peroxide is the preferred oxidant for ease of handling, cost, and lack of chemical residue. Hydrogen peroxide is easily stored as a solution and ultimately decomposes to water and oxygen, leaving no elemental or mineral residue in the tailings. The peroxide solution is supplied from a storage source 24 through a feed pump 26 into device 14 via an entry port 28 which preferably is located part way along the length of device 14, as shown in FIG. 2, to permit intense agitation and shearing in device 14 as described above prior the introduction of oxidant. Downstream of entry port 28, along the length of device 14, agitation and shearing may be maintained at a high level or may if desired be reduced.

The pH of the water phase may be raised above 7.0 by convention addition (not shown) of an alkali material, for example, sodium hydroxide and/or sodium bicarbonate.

Device 14 may be conveniently assembled from modular units like unit 14a shown in FIG. 3. For example, at an axial slurry flowrate of 0.13 ft/sec, a 10-foot module has a slurry residence time of 1.33 minutes. Thus, an assembly of ten such modules in sequence, overall 100 feet long, can accommodate a residence time of greater than 13.3 minutes.

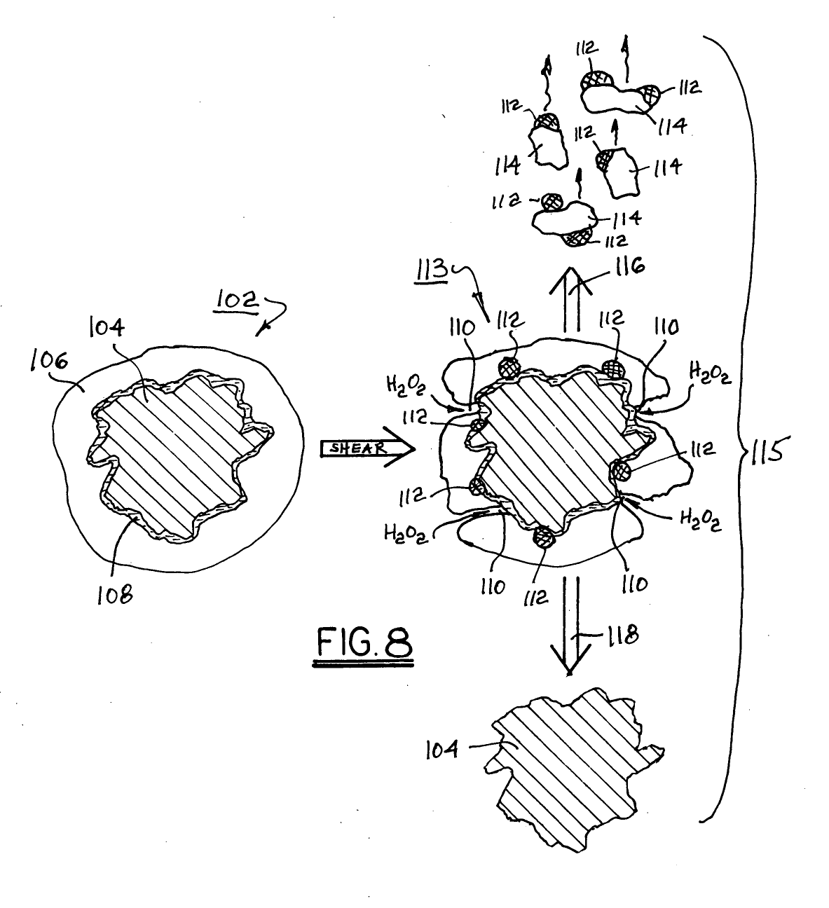

Referring now to FIG. 8, the following mechanism is presented by the inventors as one theory explaining the success of the invention, although validity of the invention does not rely upon the accuracy of such theory.

A tar sand grain 102 typically comprises a mineral particulate 104 as a core, usually a sand or clay particle, surrounded by a bitumen envelope 106. A water layer 108 is commonly present, partially or fully surrounding the mineral particulate. However, the water layer may be completely absent. The tar sand grains 102 in the slurry are subjected to intense shear as described above. Hydrogen peroxide in aqueous solution, when added to the slurry, enters into each tar sand grain 102 via one or more fractures 110 in the bitumen envelope 106 caused by the prior intense shear. Hydrogen peroxide that enters a fractured tar sand grain is decomposed by reaction with the surface of the mineral particulate, forming water plus gaseous oxygen 112. In a first separation stage 113 for each tar sand grain, the nascent gas phase immediately swells as oxygen bubbles 112 form between the bitumen envelope 106 and the particulate core 104, disrupting the structure of the tar sand grain and causing the bitumen envelope to become detached from from the mineral particulate. In a second separation stage 115 for the slurry as a whole, the oxygen bubbles 112 remain attached preferentially to the bitumen globules 114, giving the globules great buoyancy such that they rapidly migrate upwards 116 in the slurry, wherein the apparent viscosity is rapidly decreasing from decomposition of the tar sand grains. (The bubble-buoyant globules 114 are readily observable in the slurry and the bubble surfaces appear to be coated with hydrocarbon.) Conversely, most of the freed particulates 104 in the form of sand and clay fines sediment 118 rapidly, although some fines may be carried by convection upwards into the froth formed at the top of the slurry. Such incorporated sediments may be removed from the bitumen froth conventionally in a succeeding step. The buoyancy of globules 114 and oxygen bubbles 112 may be increased, and separation thereof from particulates 104 may be accelerated by subjecting tank 30 to subatmospheric pressure (vacuum) to cause bubbles 112 to increase in size. The preferred vacuum for any given recovery application may be readily determined without undue experimentation. In the separation step, a range of pressures may be useful, depending upon any specific application, for example, from about 0.1 atmospheres up to about 5 atmospheres gauge pressure.

In some applications, separation and sedimentation of fines can be enhanced by addition of an alkali material, for example, sodium hydroxide and/or sodium bicarbonate.

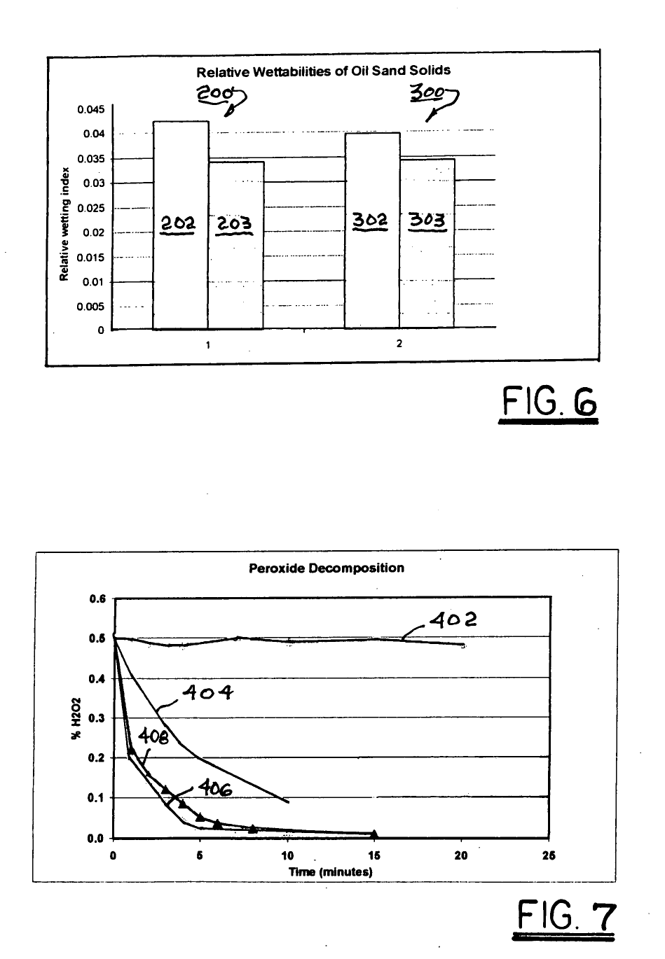

This proposed mechanism for the process of the invention is supported by laboratory data, as shown in FIGS. 6 and 7.

Referring to FIG. 6, oil sand solids were obtained by dissolving away the bitumen envelopes with solvent. To evaluate the influence of peroxide on the oil sand grains, solids recovered from bench extractions were packed into a column of 7 mm diameter and 9 cm long. The end of the column was covered with a nylon mesh, which served to retain the solids within the column while providing access for the fluid. The fluid used in these experiments was 1-propanol. After determining an initial imbibition rate for 1-propanol into the column, the column was drained and dried. A 1% hydrogen peroxide solution then was placed in the column for a period of 24 hours. The packed column was then again drained and dried, and the imbibition rate of 1-propanol determined again. The results are shown in FIG. 6. Replicate trials 200,300 were conducted. Columns 202,302 represent the imbibition rate before peroxide treatment, and columns 203,303 represent the imbibition rate after peroxide treatment. The relative wetting index was reduced significantly after treatment with hydrogen peroxide, indicating that the solids were less likely to be wet by the 1-propanol after being exposed to the peroxide. If 1-propanol can be considered to be more “oil-like” than water, then the exposure to hydrogen peroxide appears to render the grain surfaces more hydrophilic; thus, attachment of hydrophobic materials like bitumen to the sand grains would be significantly weakened.

It was previously believed, as disclosed in the '145 patent, that the observed decomposition of hydrogen peroxide is a result of reaction to a significant degree with the bitumen via Fenton's Reaction to shorten hydrocarbon chain lengths and reduce viscosity. However, further experimentation, as is shown dramatically in FIG. 6, indicates that very little reaction occurs between hydrogen peroxide and the hydrocarbon of a tar sand grain when the mineral substrate has been removed (curve 402). However, very rapid decomposition of hydrogen peroxide is seen when the hydrogen peroxide solution is exposed to only a mineral substrate from which the hydrocarbon envelope has been removed, whether the substrate be clay (curve 404) or sand (curve 406).

To find the source that is responsible for the decomposition of the peroxide, experiments were conducted on solids recovered from the extraction experiments and using a bitumen-in-water emulsion created in the laboratory. The solids were further separated into two size fractions by screening through a 325 mesh (nominally 45 μm opening) screen. For the solids, approximately 4 g of material were dispersed in 100 ml of water containing peroxide. The bitumen-in-water emulsion was used as formed (approximately 1% by weight). The bitumen-in-water emulsion separated at 80° C., so that portion of the experiment was conducted at 55° C. (For comparison purposes, the decomposition curve 408 for high grade oil sand at 55° C. has also been included.) The low rate of decomposition for the bitumen-in-water emulsion demonstrates conclusively that the decomposition of peroxide occurs when access to the surface of the solids is achieved, not through reaction with the bituminous envelope. A surprising result, however, is that the decomposition for the solids does not show dependence on the size of the solids. It was expected that the smaller size fraction (designated as <45 μm) would show higher decomposition rates. A probable explanation for this observation is that the specific sites that are responsible for the deposition far exceed the amount of peroxide present.

Continuing with the description of the process, and referring again to FIGS. 1 and 2, device 14 is in communication with a separator tank 30 for carrying out second separation stage 115. From exit port 22, the slurry is passed into separator tank 30 via line 27. Mineral particulates, substantially freed of hydrocarbons, settle out of the slurry to the bottom of the tank. For a continuous process, tank 30 is provided with a substantially flat bottom on which the layer of sand and clay accumulates. The settling particulates can mechanically trap globules of bitumen; therefore, a fluid distribution means such as a sparger bar 32 may be disposed within the tank on the bottom 31, where sand can settle upon it. A fluid, such as water or compressed air, is delivered from a source 34 to sparger bar 32 and is allowed to bubble up through the settling sand to sweep entrained bitumen up into the water/hydrocarbon phase. In some applications, it can be advantageous to add additional hydrogen peroxide and/or alkali material to the slurry at this stage to assist in the separation. Such sparging may be performed continuously or intermittently, preferably at a sufficiently low fluid flow rate that the settling sand is not significantly stirred back into the water phase.

Alternatively, the sand on bottom 31 may be mechanically agitated by a scuffle bar to allow entrapped bitumen globules to escape.

Sand that accumulates on bottom 31 may be removed, within the scope of the invention, by any means desired. In a preferred embodiment, as shown in FIG. 2, a drag chain conveyor 36 is disposed in tank 30 in proximity to and above sparger bar 32. Conveyor 36 comprises a continuous articulated belt 38 of paddles or scoops hinged together and disposed around a plurality of rollers 40 driven by a conventional drive means (not shown) in a pathway having a first portion 42 substantially parallel to bottom 31, a second portion 44 leading upwards and away from bottom 31 and out of tank 30, and a third portion 46 leading away from tank 30. Return paths are parallel and opposite to the exit paths just described. The motion of the conveyor, as shown in FIG. 2, is clockwise. Sand settling to the bottom of the tank and being cleaned of bitumen by the sparger settles through spaces in the conveyor belt and accumulates to a depth at which first conveyor portion 42 is encountered. As cleaned sand continues to accumulate, conveyor 36 sweeps the sand to the left in tank 30 and then drags excess sand up the slope of exit chute 48 and away from tank 30 to a storage site 50. The sand thus separated is wet with water, is substantially free of hydrocarbons, and is environmentally suitable for direct landfill without further treatment.

Still referring to FIG. 2, in some ores, significant amounts of bitumen may still be present by entrainment in the sand as removed from tank 30 by conveyor 36. Such bitumen may be efficiently recovered through use of a second separation tank 30′, shown schematically, wherein a new slurry may be formed by addition of water, as needed, to the sand. Commonly, sufficient residual hydrogen peroxide is present in the sand to effect separation, although more hydrogen peroxide and/or alkali material may be added from source 24 as desired. The re-cleaned particulates settle rapidly to the bottom of tank 30′ and are removed by another drag chain conveyor 36′ to storage site 50. Froth 52′ is treated as described below.

In the liquid phase in first separator 30, a froth 52 rich in hydrocarbons and buoyed by oxygen bubbles rises to the surface as the aqueous and organic phases partially separate gravitationally. Froth 52 typically contains substantial amounts of entrained water and substrate fines.

Optionally, such separation may be effected by known means such as centrifugation, filtration, settling, adsorption, absorption, or combinations thereof, of one phase from the other, or of the liquids from the particulates.

Optionally, such separation may be enhanced by further addition of water to the separator tank.

Optionally, an noted above, the rate and completeness of such separation may be enhanced by subjecting first separator 30 to subatmospheric pressure to increase the size and buoyancy of bubbles 112.

The organic phase floating on the aqueous phase near the top of tank 30 following separation therefrom preferably is drawn off via overflow pipe 54 and sent to a storage tank 56 where it is ready for shipment to a petroleum refiner. Bitumen and other hydrocarbonaceous products of the present process may be heated in tank 56 by a hot water or steam heater system 58 to reduce viscosity and promote flow as needed. The cutter stock may be recovered from the bitumen in known fashion by the refiner and returned for reuse.

Alternatively, froths 52,52′ may be removed to a separate treatment apparatus (not shown), as is typical for froths separated in accordance with the prior art. To remove most water and fines from the organic phase, the froth may be mixed with cutter stock, preferably at a ratio of about 1:1, to dilute and solubilize the bitumen, causing a further separation of the froth into an aqueous phase containing the fines and an organic phase containing the hydrocarbons. Preferably, in accordance with the invention, the froth may be treated with additional amounts of hydrogen peroxide to assist in breaking the foam. As the froth is degraded, the entrained mineral particulates settle out and the bitumen rises to the surface where it may be skimmed off for further treatment to prepare it for refining. As in the previous separation step, the rate and completeness of separation may be increased in some cases by subjecting the froths 52,52′ to subatmospheric pressure to increase the size of the oxygen bubbles attached to the bitumen globules. The separated water layer is preferably returned to the head end of the main process for efficient recycle of the heat and peroxide content, and optional alkali content, as described above.

Separator tank 30 is further provided with a partial cover 59 which includes along one edge an inverted weir 60 extending from above the surface 62 of the liquid phase downwards into the aqueous phase. The aqueous phase, still typically containing a dispersion of some portion of the clay fines, may be drawn off from tank 30 via a middling outlet port 64 at a flowrate selected such that the organic phase is not drawn under weir 60. The aqueous phase is directed to a water conditioner 66 which may comprise any of various well-known clarifying devices, including but not limited to a centrifuge, a filter, and a tailings pond. Preferably, conditioner 66 is a sand filter, which may utilize the sand in storage site 50 or other sand medium. Particle-free process water suitable for re-use is recycled from conditioner 66 through water heater system 68 into mixing tank 12. It is an important feature of the invention that the only water necessarily residual of the process is the water wetting the sand and clay. In many applications, the process water exiting the conditioner 66 may be re-used in its entirety as make-up water in the initial mixing step.

The present process may also yield gaseous hydrocarbons which are desirably collected for at least environmental reasons, and which may be present in sufficient quantity to have economic significance. Accordingly, a vacuum pump 70 is connected via vacuum lines 72 to a headspace 74 in the oxidizing vessel, a headspace 76 beneath cover 59 of the separator tank, and a headspace 78 in storage tank 56. The collected vapors 80 may be burned off to the atmosphere or may be directed for combustion in water heating system 68 or may be otherwise used. The subatmospheric conditions described above for enhancing separation may be readily provided by vacuum pump 70 and a vacuum controller (not shown) in known fashion.

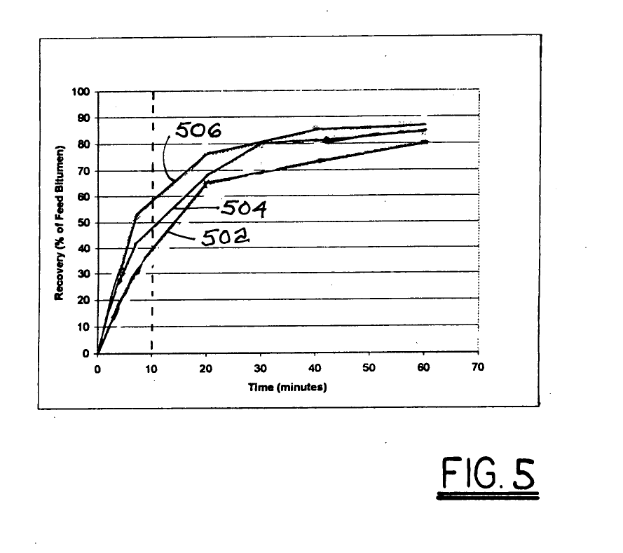

With respect to prior art bitumen recovery processes such as are discussed hereinabove, and referring now to FIG. 5, an important advantage and benefit of a bitumen recovery process employing hydrogen peroxide in accordance with the invention is a much higher initial rate of bitumen liberation from the tar sand grains. In laboratory tests using a recirculation apparatus wherein various addenda were added to a tar sand slurry and recirculated for up to one hour, curve 502 represents the rate of liberation using sodium hydroxide in a slurry at pH 8.78; curve 504, liberation using hydrogen peroxide addition at two different times; and curve 506, liberation using hydrogen peroxide at a single point and time, for example, as shown in FIG. 2. The total liberation after an hour is nearly the same for all three methods. However, separation in a commercially viable process must be as rapid as possible; processes requiring more than about 15 minutes are not useful because of the size of the plant required to hold the material for long times and still have high throughput. The much more rapid initial rate of peroxide-aided separation and flotation dramatically reduces the size requirement of a processing plant, resulting in savings which may exceed $100,000,000 per plant. In some applications, the combination of hydrogen peroxide and sodium hydroxide can result in a still higher release and recovery rate and a cleaner sand residue.

From the foregoing description it will be apparent that there has been provided improved methods and apparatus for economically recovering petroleum-like hydrocarbon residues from particulate mineral substrates, especially hydrocarbonaceous ores, and for discharging a substrate residue environmentally suitable for landfill disposal. Variations and modifications of the herein described methods and apparatus, in accordance with the invention, will undoubtedly suggest themselves to those skilled in this art. Accordingly, the foregoing description should be taken as illustrative and not in a limiting sense.

What is claimed is:

1. A method for separating bitumen material from mineral particulates in grains of a hydrocarbonaceous ore, wherein a step in said method includes formation of an aqueous slurry of said ore, and wherein said aqueous slurry comprises a peroxide and an alkali material.

2. A method in accordance with claim 1 wherein said slurry is at a pH greater than 7.0.

3. A method in accordance with claim 1 wherein said peroxide is hydrogen peroxide.

4. A method in accordance with claim 1 wherein said alkali material is selected from the group consisting of sodium hydroxide and sodium bicarbonate.

5. A method for separating bitumen material from mineral particulates in grains of a hydrocarbonaceous ore, comprising the steps of:
a) mixing said ore with water to form an aqueous slurry of said grains;
b) tempering said slurry to a temperature between about 20° C. and 150° C.;
c) adding an alkali material to said slurry to raise the slurry pH above 7.0;
d) shearing said slurry for at least one minute;
e) adding a peroxide to said slurry;
f) forming oxygen bubbles between said bitumen material and said mineral particulates within said grains by decomposing a portion of said peroxide therein; and
g) separating said bitumen material from said mineral particulates.

6. A method in accordance with claim 5 comprising the further steps of:
a) attaching oxygen bubbles to said bitumen material;
b) buoying said separated bitumen material upwards in said slurry to form a bitumen-rich froth upon a primary water phase thereof; and
c) recovering said bitumen-rich froth from said primary water phase.

7. A method in accordance with claim 6 comprising the further step of subjecting said slurry to subatmospheric pressure to enhance said buoying and recovering steps.

8. A method in accordance with claim 6 comprising the further step of adding an alkaline material to said slurry in said buoying step.

9. A method in accordance with claim 6 comprising the further steps of:
a) settling said mineral particulates in said primary water phase; and
b) removing said settled mineral particulates from said primary water phase.

10. A method in accordance with claim 9 comprising the further steps of:
a) adding water to said removed mineral particulates to form a second slurry;
b) agitating said second slurry to separate entrained second bitumen material from said mineral particulates;
c) attaching oxygen bubbles to said second bitumen material;
d) buoying said separated second bitumen material upwards in said slurry to form a bitumen-rich froth upon a second water phase thereof; and
e) recovering said separated second bitumen material from said second water phase,
wherein the pH of said second slurry is adjusted to be greater than 7.0.

11. A method in accordance with claim 10 comprising the further step of adding hydrogen peroxide to said second slurry.

12. A method in accordance with claim 10 comprising the further steps of:
a) adding water to said bitumen-rich froth;
b) adding hydrogen peroxide to said bitumen-rich froth to cause additional separation of said froth into a bitumen layer, a water layer, and a mineral particulates layer.

13. A method in accordance with claim 10 further comprising the step of adding an alkali material to said bitumen-rich froth to raise the pH of said froth above 7.0.

14. A method in accordance with claim 5 wherein said shearing is carried out at a shear rate generated by an average slurry velocity of at least one meter per second.

15. A method in accordance with claim 14 wherein said shear rate is generated by an average slurry velocity of between two and five meters per second.

16. A method in accordance with claim 5 wherein said shearing step is carried out for at least one minute before said step of adding peroxide.

17. A method in accordance with claim 5 wherein said shearing step is carried out for between about 8 minutes and about 16 minutes before said step of adding peroxide.

18. A method in accordance with claim 5 wherein said shearing of said slurry is continued after said step of adding peroxide.

19. A method in accordance with claim 5 wherein at least a portion of said method is carried out at a gauge pressure of about 1 atmosphere.

20. A method in accordance with claim 5 wherein at least a portion of said method is carried out at a gauge pressure of between about 0.1 atmosphere and about 5 atmospheres.

21. A method in accordance with claim 20 further comprising the step of adding a cutter stock to said bitumen as a part of said recovering step.

22. A method in accordance with claim 20 wherein said recovering step includes a method selected from the group consisting of gravity flotation, air flotation, settling, decanting, filtration, centrifugation, and combinations thereof.

23. A method in accordance with claim 22 further comprising the step of recycling at least a portion of said water from said water phase into said mixing step to form said slurry.

24. A method in accordance with claim 23 wherein said sand is employed as a filter for said water being recycled into said mixing step.

25. A method in accordance with claim 5 wherein said peroxide is present in said slurry after said adding step in an amount between 0.05 weight percent and about 10.0 weight percent relative to the weight of water in said slurry, said percents being expressed as equivalent weights of hydrogen peroxide.

26. A method in accordance with claim 5 further comprising the step of adjusting the weight ratio of water to ore to between about 1:4 and about 2:1 during said mixing step.

27. A method in accordance with claim 5 wherein said ore is selected from the group consisting of tar sands, oil sands, oil shales, oil sandstones, and prior-process tailings.

28. A method in accordance with claim 5 wherein said ore includes clay-size particles.

29. A method in accordance with claim 5 wherein said mineral substrate includes quartz sand.

30. A method in accordance with claim 5 wherein said method is carried out in a process type selected from the group consisting of continuous, semi-continuous, batch, and combinations thereof.

31. A method in accordance with claim 5 further comprising the step of treating said ore prior to said mixing step.

32. A method in accordance with claim 31 wherein said treating is selected from the group consisting of sieving, sorting, crushing, grinding, and combinations thereof.

33. A method in accordance with claim 31 wherein said treating is carried out with the assistance of a rotary trommel screen.

34. A method in accordance with claim 5 further comprising the step of collecting gaseous hydrocarbons generated in said method.

35. A method in accordance with claim 5 wherein said water is selected from the group consisting of fresh water, sea water, salt water, tailing pond water, recycled process water, and combinations thereof.

36. A system for separating bitumen material from mineral particulates in grains of a hydrocarbonaceous ore comprising:
a) means for mixing said ore with water to form an aqueous slurry of said grains;
b) means for tempering said slurry to a temperature between about 20° C. and 100° C.;
c) means for adding an alkali material to said slurry to raise the slurry pH above 7.0;
d) means for shearing said slurry for at least one minute;
e) means for adding a peroxide to said slurry;
f) means for forming oxygen bubbles between said bitumen material and said mineral particulates within said grains by decomposing a portion of said peroxide therein; and
g) means for separating said bitumen material from said mineral particulates.

37. A system in accordance with claim 36 further comprising:
a) means for buoying said separated bitumen material upwards in said slurry to form a bitumen-rich froth upon a water phase thereof; and
c) means for recovering said separated bitumen material from said water phase.

38. A system in accordance with claim 37 further comprising:
a) means for settling said mineral particulates in said water phase; and
b) means for removing said settled mineral particulates from said water phase.

39. A system in accordance with claim 36 wherein said peroxide is selected from the group consisting of hydrogen peroxide and sodium peroxide.

40. A system in accordance with claim 36 wherein said temperature is about 80° C.

41. A system in accordance with claim 36 wherein said shearing means is capable of shearing said slurry at a shear rate produced by a slurry average velocity of at least one meter per second.

42. A system in accordance with claim 41 wherein said shearing means is capable of shearing said slurry at a shear rate by a slurry average velocity of at least five meters per second.

43. A system in accordance with claim 36 wherein said separating bitumen material from mineral particulates may be carried out at a gauge pressure of up to about 1 atmosphere.

44. A system in accordance with claim 36 wherein at least a portion of said separating bitumen material from mineral particulates may be carried out at a gauge pressure of between about 1 atmosphere and about 5 atmospheres.

45. A system in accordance with claim 36 further comprising means for subjecting said slurry to subatmospheric pressure.

46. A system in accordance with claim 37 further comprising means for adding a cutter stock to said bitumen.

47. A system in accordance with claim 37 wherein said means for recovering step includes means selected from gravity flotation, air flotation, settling, decanting, filtration, centrifugation, and combinations thereof.

48. A system in accordance with claim 37 further comprising means for recycling at least a portion of said water from said water phase into said mixing step to form said slurry.

49. A system in accordance with claim 36 further comprising means for treating said ore prior to said mixing step.

50. A system in accordance with claim 49 wherein said means for treating is selected from the group consisting of sieving, sorting, crushing, grinding, and combinations thereof.

51. A system in accordance with claim 49 wherein said means for treating includes a rotary trommel screen.

52. A system in accordance with claim 36 further comprising means for collecting gaseous hydrocarbons.

53. A system in accordance with claim 36 wherein said shearing means includes a plurality of mixers.

54. A system in accordance with claim 36 wherein said shearing means and said peroxide-adding means includes a linear oxidation vessel capable of producing a low axial flow velocity and a high tangential and rotational flow velocity in said slurry.

55. A system in accordance with claim 38 wherein said means for settling and said means for removing includes a separating tank.

56. A system in accordance with claim 55 wherein said means for removing includes a drag chain conveyor.

57. A system in accordance with claim 55 wherein said means for settling and said means for removing includes a sparger.

58. A system in accordance with claim 55 wherein said separating tank includes an inverted weir.

59. A system in accordance with claim 36 further comprising means for heating said water prior to adding said water to said mixing means.

60. A system in accordance with claim 36 wherein said mixing means includes a first vessel, said shearing means includes a second vessel, and said separating means includes a third vessel.

61. A system in accordance with claim 60 wherein said first vessel is a mixing tank, said second vessel is a shearing device, and said third vessel is a separation tank.

62. A system in accordance with claim 60 wherein at least said second and third vessels are configured for continuous flow therethrough.

63. A system in accordance with claim 36, further comprising:
a) means for adding water to said removed mineral particulates to form a second slurry;
b) means for agitating said second slurry to separate entrained second bitumen material from said mineral particulates;
c) means for attaching oxygen bubbles to said second bitumen material;
d) means for buoying said separated second bitumen material upwards in said second slurry to form a bitumen-rich froth upon a second water phase thereof; and
e) means for recovering said separated second bitumen material from said second water phase.

64. A system in accordance with claim 63 further comprising means for adding hydrogen peroxide to said second slurry.

65. A system in accordance with claim 63 further comprising means for adding an alkali material to said second slurry.

66. A system in accordance with claim 63 further comprising:
a) means for settling said mineral particulates in said secondary water phase; and
b) means for removing said settled mineral particulates from said secondary water phase.
